(19) United States
(12) Patent Application Publication
(10) Pub. No.: US 2014/0229997 A1
(43) Pub. Date: Aug. 14, 2014

(54) SATELLITE BROADCASTING AND COMMUNICATION TRANSMITTING METHOD AND APPARATUS OPERABLE IN BROAD SIGNAL TO NOISE RATIO (SNR) ENVIRONMENT

(71) Applicant: Electronics and Telecommunications Research Institute, Daejeon (KR)

(72) Inventors: Pan Soo KIM, Daejeon (KR); Deock Gil OH, Daejeon (KR)

(73) Assignee: Electronics and Telecommunications Research Institute, Daejeon (KR)

(21) Appl. No.: 14/175,496

(22) Filed: Feb. 7, 2014

(30) Foreign Application Priority Data
Feb. 8, 2013 (KR) 10-2013-0014488
Jul. 15, 2013 (KR) 10-2013-0082894

(51) Int. Cl. H04N 21/61; H04N 21/4408; H04B 1/69

(52) U.S. Cl. CPC H04N 21/6193; H04B 1/69; H04N 21/4408
USPC 725/67

(57) ABSTRACT

Provided is a technology applicable to a broad signal to noise ratio (SNR) environment for a satellite communication and broadcasting service, including a mapper to modulate a forward error correction frame based on a predetermined constellation, a physical layer header processor to add a physical layer header to the modulated forward error correction frame, a physical layer frame spreader to spread a physical layer frame of the modulated forward error correction frame, and a physical layer scrambler to scramble the added physical layer header and the spread physical layer frame.

### CROSS-REFERENCE TO RELATED APPLICATIONS

This application claims the priority benefit of Korean Patent Application No. 10-2013-0014488, filed on Feb. 8, 2013, and Korean Patent Application No. 10-2013-0082894, filed on Jul. 15, 2013, in the Korean Intellectual Property Office, the disclosures of which are incorporated herein by reference.

### BACKGROUND

1. Field of the Invention

The present invention relates to a technical idea applicable to a broad signal to noise ratio (SNR) environment when providing a satellite communication and broadcasting service.

2. Description of the Related Art

An existing Digital Video Broadcasting-Satellite-Second generation (DVB-S2) based transmission system may perform transmission suitable for a channel environment having a signal to noise ratio (SNR) range of 2.35 decibels (dB) to approximately 16 dB. However, in a case of satellite communication, an excessively low SNR may occur due to rain or installation of an antenna. Also, in a case of a mobile terminal, when transmitting a high SNR signal, interference may occur in an adjacent channel due to an antenna pointing error. Thus, when receiving and transmitting a satellite signal, the signal may be transmitted in an excessively low SNR environment. Under a current DVB-S2 standard, numerous transceivers have been installed and thus, a new framework may not be executed. Accordingly, configuring a frame that may not affect existing devices may be necessary.

Technologies that may be used to achieve this purpose may include spread-spectrum technology. However, an existing spread-spectrum technology may need an additional device to perform a spread-spectrum function, and a receiver not supporting the spread-spectrum function may not receive data easily.

In general, satellite communication may operate in a fixed bandwidth. The spread-spectrum technology may generally refer to technology for spreading a signal bandwidth to transmit a low signal power. Various methods may be used to spread the bandwidth, among which a simple method may include duplicating identical data, transmitting the data, and combining the data in a receiver to improve signal intensity.

In general, simultaneous use of the spread-spectrum technology and a non-spread spectrum technology may reduce data quantity of a signal applicable to the spread spectrum from a fixed bandwidth. In a case in which the data quantity is reduced in DVB-S2, numerous dummy frames may occur. The dummy frames may be replaced with a form in which an existing frame is repeated.

In general, the spread-spectrum technology may include, in sequence, a symbol repeating technology, a frame repeating technology, and a frequency repeating technology.

In a case of satellite communication, the frequency repeating technology using a nonlinear amplifier may cause intermoulation distortion and thus, a multicarrier technology may not be applied easily.

The symbol repeating technology may be generally referred to as a direct sequence spread spectrum, although an existing DVB-S2 receiver may not receive a signal waveform of the direct sequence spread spectrum.

Reception may not be possible by the frame repeating technology in a low SNR environment.

Synchronous accumulation of each received signal may be available, however, in a case of Adaptive Coding and Modulation (ACM) being used in DVB-S2, carrier synchronization accumulation and carrier recovery accumulation may not be available, because a length of the frame may change.

In a case of communication in an existing low SNR environment, transmission may be performed by repeating a symbol and encoding a channel. The repeating of the symbol may include a scrambling process to achieve spectrum flatness and be simply performed only by accumulating the repeating symbol. The encoding of the channel may be considered an effective technology to improve performance in a low SNR environment, although may not be applicable when carrier recovery does not occur due to a low received signal.

Implementation of both the repeating and the encoding may be possible in an existing narrowband or broadband service. In the existing DVB-S2 standard, a transmission method available in the low SNR environment may be performed using a Low-Density Parity-Check (LDPC) code, a Quadrature Phase Shift Keying (QPSK)+code rate of 1/4.

### SUMMARY

According to an aspect of the present invention, there is provided a satellite broadcasting and communication transmitter including a mapper to modulate a forward error correction frame based on a predetermined constellation, a physical layer header processor to add a physical layer header to the modulated forward error correction frame, a physical layer frame spreader to spread a physical layer frame of the modulated forward error correction frame, and a physical layer scrambler to scramble the added physical layer header and the spread physical layer frame.

The physical layer scrambler may perform scrambling by repeating the added physical layer header a predetermined number of times.

The physical layer scrambler may scramble a portion of the repeated physical layer header.

The physical layer scrambler may scramble a remaining portion of the repeated physical layer header from which a first physical layer header is excluded.

The physical layer scrambler may scramble a remaining portion of the repeated physical layer header from which a Start Of Frame (SOF) of a predetermined symbol is excluded.

The physical layer scrambler may perform the scrambling based on a scrambling code generated by a sequence generator in a predetermined sequence.

The physical layer frame spreader may repeat the physical layer frame based on a spreading factor.

The mapper may determine a bit mapping of the forward error correction frame based on at least one of an applicable area and a status of a transmission channel, and perform the bit mapping based on at least one constellation among π/2 Binary Phase Shift Keying (BPSK), Quadrature Phase Shift Keying (QPSK), 8 Phase Shift Keying (8PSK), 16 Amplitude and Phase Shift Keying (16APSK), 32APSK, and 64APSK.

According to another aspect of the present invention, there is provided a satellite broadcasting and communication transmitting method including modulating, by a mapper, a forward error correction frame based on a predetermined constellation, adding, by a physical layer header processor, a physical layer header to the modulated forward error correction frame, spreading, by a physical layer frame spreader, a physical layer frame of the modulated forward error correction frame, and scrambling, by a physical layer scrambler, the added physical layer header and the spread physical layer frame.

The scrambling may include performing scrambling by repeating the added physical layer header a predetermined number of times.

The performing of the scrambling by repeating the added physical layer header may include scrambling a remaining portion of the repeated physical layer header from which a first physical layer header or a SOF of a predetermined symbol is excluded.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a satellite broadcasting and communication transmitter according to an embodiment of the present invention;

FIG. 2 is a block diagram illustrating a satellite broadcasting and communication transmitter according to another embodiment of the present invention;

FIG. 3 is a diagram illustrating a frame structure used for a satellite broadcasting and communication transmitter according to an embodiment of the present invention;

FIG. 4 is a diagram illustrating a 64 Amplitude and Phase Shift Keying (64APSK) constellation used for modulation of a satellite broadcasting and communication transmitter according to an embodiment of the present invention;

FIG. 5 is a diagram illustrating a link structure used for a satellite broadcasting and to communication transmitter according to an embodiment of the present invention;

FIG. 6 is a block diagram illustrating a receiver corresponding to a satellite broadcasting and communication transmitter according to an embodiment of the present invention; and

FIG. 7 is a flowchart illustrating a satellite broadcasting and communication transmitting method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

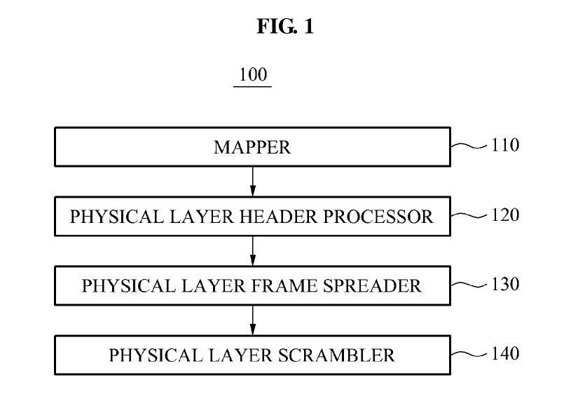

FIG. 1 is a block diagram illustrating a satellite broadcasting and communication transmitter 100 according to an embodiment of the present invention. The satellite broadcasting and communication transmitter 100 may implement a satellite transceiver operable in a broad signal to noise ratio (SNR) environment, particularly in a low SNR environment, and be applicable to a Digital Video Broadcasting-Satellite-Second generation (DVB-S2) standard based network.

The satellite broadcasting and communication transmitter 100 may include a mapper 110, a physical layer header processor 120, a physical layer frame spreader 130, and a physical layer scrambler 140.

The mapper 110 may modulate a forward error correction frame based on a predetermined constellation.

For example, the mapper 110 may modulate the forward error correction frame based on at least one constellation of 8 Phase Shift Keying (8PSK), 16 Amplitude and Phase Shift

Keying (16APSK), 32APSK, or 64APSK.

The physical layer header processor 120 may add a physical layer header to the modulated forward error correction frame.

The physical layer frame spreader 130 may spread a physical layer frame of the modulated forward error correction frame.

For example, when the physical layer frame spreader 130 uses a predetermined spreading factor of 2 or 5, a symbol may be repeated two or five times in association with a Binary Phase Shift Keying (BPSK) modulation of a data area.

The physical layer scrambler 140 may scramble the added physical layer header and the spread physical layer frame.

The physical layer scrambler 140 may perform the scrambling by repeating the added physical layer header a predetermined number of times.

For example, the physical layer scrambler 140 may scramble a portion of the repeated physical layer header. More particularly, the physical layer scrambler 140 may scramble a remaining portion of the repeated physical layer header from which a first physical layer header or a Start Of Frame (SOF) of a predetermined symbol is excluded.

Here, the physical layer scrambler 140 may perform the scrambling based on a scrambling code generated by a sequence generator in a predetermined sequence.

According to an embodiment of the present invention, the satellite broadcasting and communication transmitter 100 may generate the physical layer header subsequent to the to BPSK modulation in the forward error correction frame. Afterwards, the physical layer header may be repeated five times to be detected in an environment where a SNR is −10 decibels (dB).

For example, when the physical layer header configured with a 180 symbol is repeated a predetermined number of times, for example, five times, a spectrum issue caused by a repetition of identical data may be resolved. According to an embodiment of the present invention, the satellite broadcasting and communication transmitter 100 may not scramble the first physical layer header or the SOF of a 26 symbol of each physical layer header. The scrambling code may be generated by a 10th ‘m’ sequence generator and another correlative code may be applicable. After the symbol is repeated two or five times for the BPSK modulation of the data area, signals may be mixed by a physical layer scrambling code of DVB-S2.

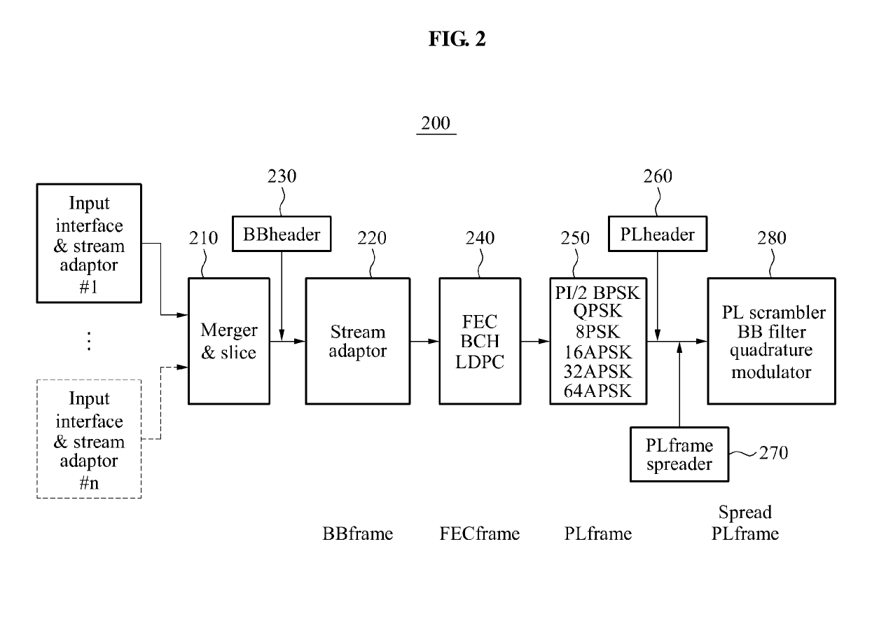

FIG. 2 is a block diagram illustrating a satellite broadcasting and communication transmitter 200 according to another embodiment of the present invention.

The satellite broadcasting and communication transmitter 200 may include structures for satellite broadcasting and communication transmission, for example, a mode adaptor 210, a stream adaptor 220, a base band (BB) header 230, and a forward error correction (FEC) 240, or a BCH+Low-Density Parity-Check (LDPC) encoder. The satellite broadcasting and communication transmitter 200 may also include structures for spread-spectrum transmission and scrambling, for example, a mapper 250, a physical layer header processor 260, a physical layer frame spreader 270, and a physical layer scrambler 280.

A general transmitter may include an input stream interface, a merger and slice configuring unit, a BB header inserter, a stream adaptor, an FEC, or BCH+LDPC, encoder, a modulator, and a physical layer frame configuring unit, a physical layer header inserter, a BB filter, and a quadrature modulator. Here, a PSK modulation, repetition of a symbol of a physical layer header and a physical layer frame, and physical layer scrambling may be added.

More particularly, the satellite broadcasting and communication transmitter 200 may include the mode adaptor 210, the stream adaptor 220, the FEC encoder 240, the mapper 250, the physical layer header processor 260, the physical layer frame spreader 270, and the physical layer scrambler 280.

The mod adaptor 210 may be determined based on an application, and perform functions such as an input stream interface, an input stream recovery, an elimination of a null-packet for an Adaptive Coding and Modulation (ACM) mode and a Transport Stream (TS) input format, a Cyclic Redundancy Check-8 (CRC-8) encoding for error detection, and an input stream mixing function for a multi-input stream. The BB header 230, as a frame configuring format, may be provided at a front end of a data field to inform a receiver of an input stream format and a form of the mode adaptor 210.

The stream adaptor 220 may perform padding and BB scrambling to form a BB frame.

The FEC encoder 240 may correct an error based on an external code such as BCH, and an internal code such as LDPC with various code rates, and determine a length of a FEC code block to be 64,800 bit or 16,200 bit based on an application.

Also, the FEC encoder 240 may perform a bit interleaving with 8PSK, 16APSK, 32APSK, and 64APSK modulation, but not perform the bit interleaving with BPSK and Quadrature Phase Shift Keying (QPSK) modulation.

The mapper 250 may perform modulation based on π/2 BPSK, QPSK, 8PSK, 16APSK, 32APSK, or 64APSK constellations, and determine a bit mapping based on an applicable area or a status of a transmission channel. Also, the mapper 250 may add a physical layer header by performing 16K LDPC encoding with the π/2 BPSK modulation to form a spread frame with a length of 16290 and thus, replace an existing Modulation and Coding (MODCOD) frame with the spread frame.

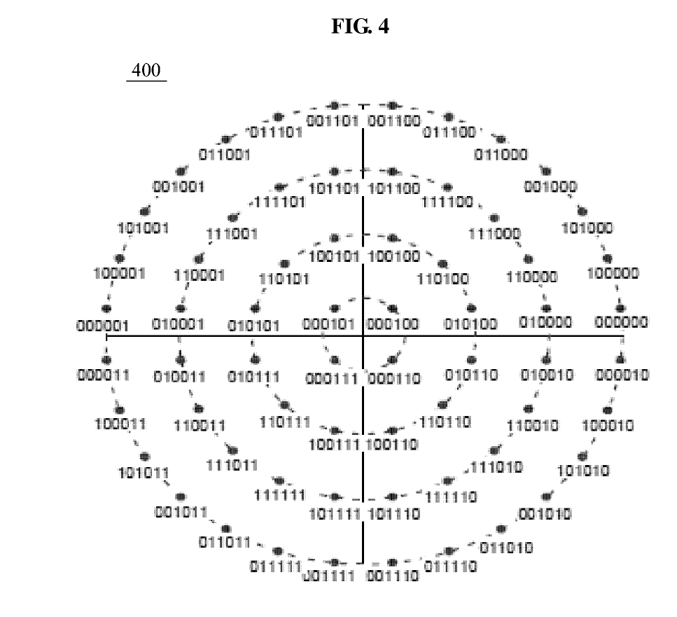

For example, FIG. 4 is a diagram illustrating a 64APSK constellation used for modulation of a satellite broadcasting and communication transmitter. Here, the modulation may be performed based on indicated 64 sets of amplitude and phase.

To obtain a low bit error rate, a gray mapping may be performed in π/2 BPSK, QPSK, or 8PSK constellation.

The physical layer header processor 260 may insert the physical layer header in the replaced spread frame, and the physical layer frame spreader 270 may repeat a physical layer frame inserted with the physical layer header based on a spreading factor.

The physical layer scrambler 280 may scramble the physical layer frame to which the physical layer header is inserted, based on the spreading factor.

According to an embodiment of the present invention, the physical layer header may be generated by the physical layer header processor 260 subsequent to the BPSK modulation in the forward error correction frame. The physical layer frame spreader 270 may repeat the physical layer header five times to be detected in an environment where a SNR is −10 dB and insert the physical layer header in the physical layer frame.

The physical layer scrambler 280 may scramble a portion of the repeated physical layer header.

For example, the physical layer scrambler 280 may scramble a remaining portion of the repeated physical layer header from which a first physical layer header is excluded.

For another example, the physical layer scrambler 280 may scramble a remaining portion of the repeated physical layer header from which a SOF portion of a predetermined symbol, for example, a 26 symbol, is excluded.

In other words, the physical layer scrambler 280 may not scramble the first physical layer header or the SOF portion of the 26 symbol to resolve a spectrum issue caused by repetition of identical data while the physical layer header configured with a 180 symbol is repeated five times.

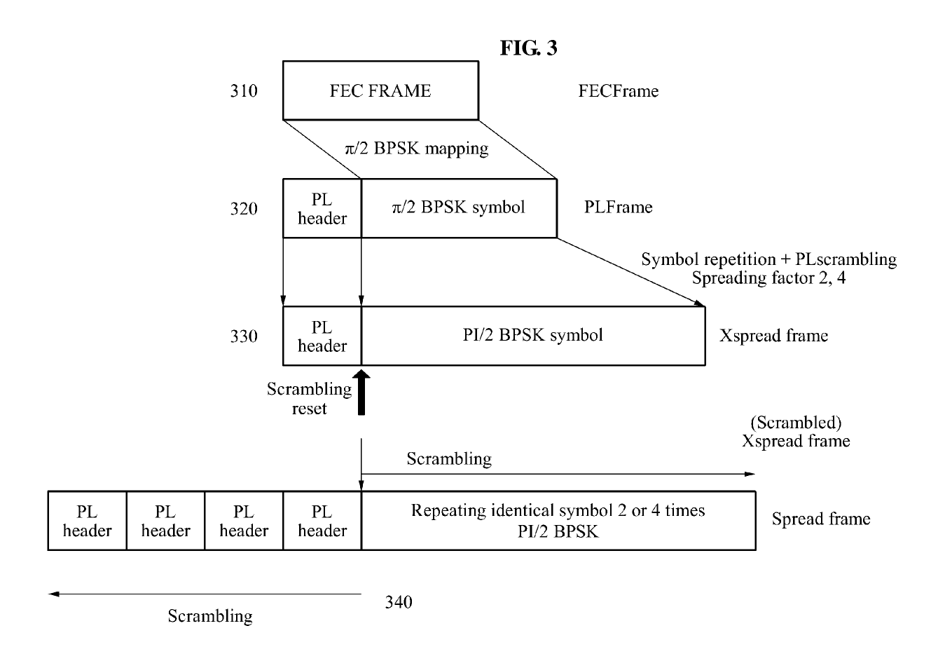

FIG. 3 is a diagram illustrating a frame structure used for a satellite broadcasting and to communication transmitter according to an embodiment of the present invention.

To operate the satellite broadcasting and communication transmitter in a broad SNR environment, the frame structure may be configured as shown in FIG. 3.

In a forward error correction frame 310, a physical layer header may be added as shown in 320, by a physical layer header processor, and a data area of a π/2BPSK symbol may be generated based on π/2BPSK mapping.

As shown in 330, in the data area, a symbol repetition and a physical layer scrambling may be performed based on a spreading factor. For example, when the spreading factor is 2 or 4, a symbol may be repeated two or four times during the BPSK modulation in the data area and signals may be scrambled by a physical layer scrambling code.

As shown in 340, the physical layer header may be repeated four times to be detected in an environment where a SNR is −10 dB. A first physical layer header or a SOF of a 26 symbol in each physical layer header may not be scrambled to resolve a spectrum issue caused by repetition of identical data when the physical layer header configured with a 180 symbol is repeated four times.

When a physical layer scrambling sequence cycle is short, the BPSK modulation in the data area may occur from the start periodically.

As indicated in Table 1, an existing DVB-S2 16APSK modulation MODCOD may exist in six forms. The modulation method may be replaced with π/2BPSK, and a code rate may be determined to be ¼ or ⅓ and a spreading factor may be determined

TABLE 1

| | | The MSB | The MSB |
|---|---|---|---|
| | | of the TYPE | of the TYPE |
| Mode | MODCOD | field(16K/64K) | field(Pilot/Nonpilot) |
| π/2BPSK 1/4 | 1D | 1/0 | 1 |
| and Spreading | | | |
| Factor(SF) 1 | | | |
| π/2BPSK 2/3 | 2D | 1/0 | 1 |
| and Spreading | | | |
| Factor(SF) 1 | | | |
| π/2BPSK 1/4 | 3D | 1/0 | 1 |
| and Spreading | | | |
| Factor(SF) 2 | | | |
| π/2BPSK 2/3 | 4D | 1/0 | 1 |
| and Spreading | | | |
| Factor(SF) 2 | | | |
| π/2BPSK 1/4 | 5D | 1/0 | 1 |
| and Spreading | | | |
| Factor(SF) 4 | | | |
| π/2BPSK 2/3 | 6D | 1/0 | 1 |
| and Spreading | | | |
| Factor(SF) 4 | | | |

FIG. 4 is a diagram illustrating a 64APSK constellation used for modulation of a satellite broadcasting and communication transmitter according to an embodiment of the present invention.

The satellite broadcasting and communication transmitter may modulate a forward error correction frame based on the 64APSK constellation.

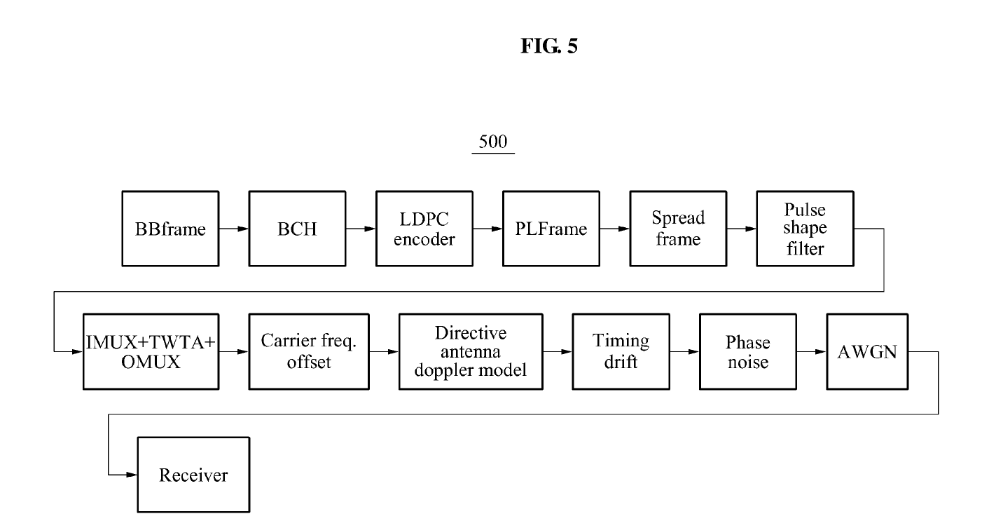

FIG. 5 is a diagram illustrating a link structure 500 used for a satellite broadcasting and communication transmitter according to an embodiment of the present invention.

Referring to FIG. 5, a BB frame may be a frame configured subsequent to a stream adaptor, and a physical layer frame may be generated after a BCH and LDPC encoding process.

Subsequently, a spread frame may be generated, and a pulse shape filter and a transponder model such as an input multiplexer (MUX), a Traveling Wave Tube Amplifier (TWTA), and an output MUX, may be included.

A frequency error, a Doppler error, a timing error, phase noise, white noise, and the like may be added to be input to a receiver.

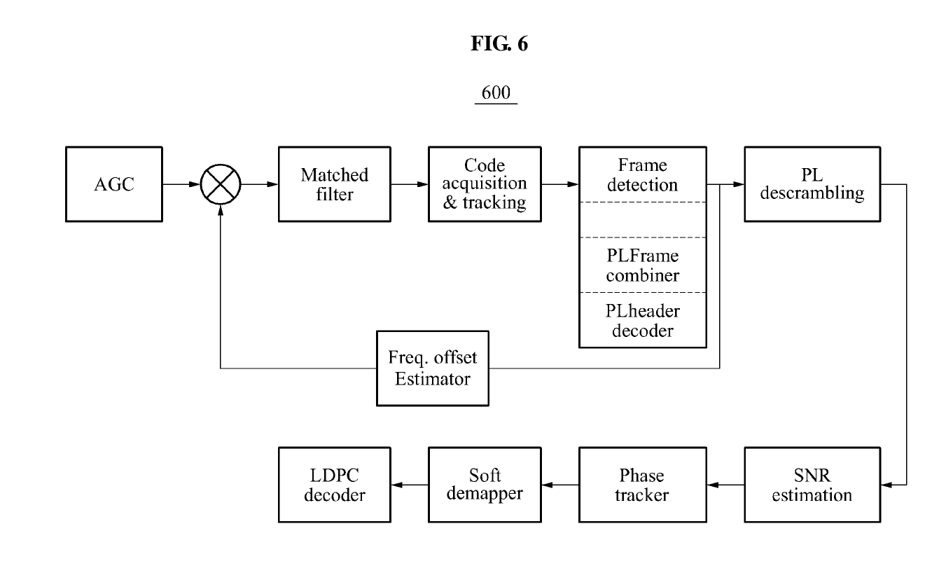

FIG. 6 is a block diagram illustrating a receiver 600 corresponding to a satellite broadcasting and communication transmitter according to an embodiment of the present invention.

The receiver 600 may be a DVB-S2 standard based receiver including an Automatic Gain Control (AGC) unit, a matched filter, a symbol recovery unit, a frame detector, a spreading factor detector, a physical layer header detector, and a physical layer descrambler.

The AGC unit may adjust a signal level of an input signal based on AGC. Subsequent to processing by the matched filter, the symbol recovery unit may perform symbol recovery.

The frame detector may detect a frame and the spreading factor detector may detect a spreading factor.

The physical layer header detector may combine the frame and detect a physical layer header, and interact with processes of frame detection, detection of the spreading factor, frame combination, and detection of the physical layer header.

The physical layer descrambler may correct a frequency and descramble a physical layer.

Also, the DVB-S2 standard based receiver 600 may perform SNR estimation, phase recovery, soft decision decoding, and LDPC decoding. A difference between the present invention and a related existing invention may be that the frame detection, the detection of the spreading factor, the frame combination, and the detection of the physical layer header operate interactively.

Another difference may be that frame recovery may be facilitated using a repeated symbol pattern in a data area, along with a SOF of an existing physical layer header or physical layer signaling (PLS), when detecting the frame recovery. The PLS may be detected through frequency recovery and phase recovery and be used for the data decoding.

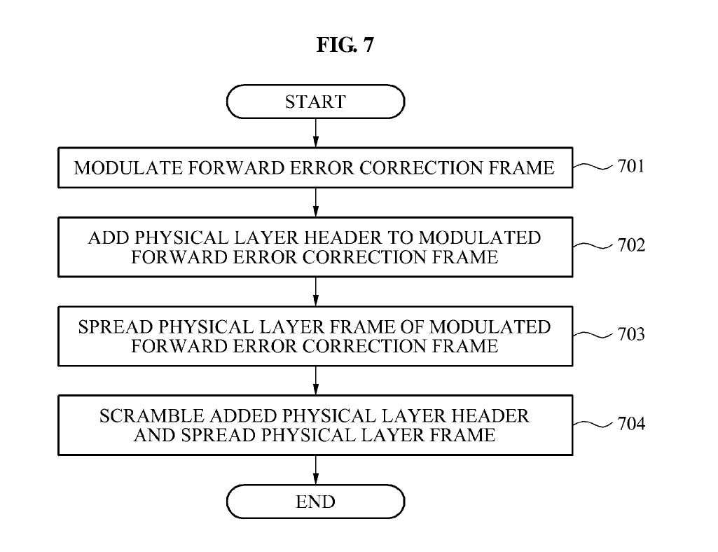

FIG. 7 is a flowchart illustrating a satellite broadcasting and communication transmitting method according to an embodiment of the present invention.

In operation 701, a mapper may modulate a forward error correction frame based on a predetermined constellation.

For example, the forward error correction frame may be modulated based on an 8PSK, 16APSK, 32APSK, or 64APSK constellation.

In operation 702, a physical layer header processor may add a physical layer header to the modulated forward error correction frame.

In operation 703, a physical layer frame spreader may spread a physical layer frame of the modulated forward error correction frame.

For example, a predetermined spreading factor may be used. When the spreading factor is 2 or 5, a symbol may be repeated two or five times for a BPSK modulation in a data area.

In operation 704, a physical layer scrambler may scramble the added physical layer header and the spread physical layer frame.

Here, the satellite broadcasting and communication transmitting method may include performing the scrambling by repeating the added physical layer header a predetermined number of times.

Also, to perform the scrambling by repeating the added physical layer header, a remaining portion of the physical layer header from which a first physical layer header or a SOF portion of a predetermined portion is excluded may be scrambled.

According to an embodiment of the present invention, a satellite transceiver operable in a low SNR environment may be implemented.

According to another embodiment of the present invention, a satellite broadcasting and communication transmitting apparatus and method operable in a broad SNR environment may be applied to an existing DVB-S2 standard based network.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; to magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A satellite broadcasting and communication transmitter, the transmitter comprising:
a mapper to modulate a forward error correction frame based on a predetermined constellation;
a physical layer header processor to add a physical layer header to the modulated forward error correction frame;
a physical layer frame spreader to spread a physical layer frame of the modulated forward error correction frame; and
a physical layer scrambler to scramble the added physical layer header and the spread physical layer frame.

2. The transmitter of claim 1, wherein the physical layer scrambler performs scrambling by repeating the added physical layer header a predetermined number of times.

3. The transmitter of claim 2, wherein the physical layer scrambler scrambles a portion of the repeated physical layer header.

4. The transmitter of claim 3, wherein the physical layer scrambler scrambles a remaining portion of the repeated physical layer header from which a first physical layer header is excluded.

5. The transmitter of claim 3, wherein the physical layer scrambler scrambles a remaining portion of the repeated physical layer header from which a Start Of Frame (SOF) of a predetermined symbol is excluded.

6. The transmitter of claim 1, wherein the physical layer scrambler performs the scrambling based on a scrambling code generated by a sequence generator in a predetermined sequence.

7. The transmitter of claim 1, wherein the physical layer frame spreader repeats the physical layer frame based on a spreading factor.

8. The transmitter of claim 1, wherein the mapper determines a bit mapping of the forward error correction frame based on at least one of an applicable area and a status of a transmission channel, and performs the bit mapping based on at least one constellation among π/2 Binary Phase Shift Keying (BPSK), Quadrature Phase Shift Keying (QPSK), 8 Phase Shift Keying (8PSK), 16 Amplitude and Phase Shift Keying (16APSK), 32APSK, and 64APSK.

9. A satellite broadcasting and communication transmitting method, the method comprising:
modulating, by a mapper, a forward error correction frame based on a predetermined constellation;
adding, by a physical layer header processor, a physical layer header to the modulated forward error correction frame;
spreading, by a physical layer frame spreader, a physical layer frame of the modulated forward error correction frame; and
scrambling, by a physical layer scrambler, the added physical layer header and the spread physical layer frame.

10. The method of claim 9, wherein the scrambling comprises performing scrambling by repeating the added physical layer header a predetermined number of times.

11. The method of claim 10, wherein the performing of the scrambling by repeating the added physical layer header comprises scrambling a remaining portion of the repeated physical layer header from which a first physical layer header or a Start Of Frame (SOF) of a predetermined symbol is excluded.
